(19) United States
(12) Patent Application Publication
(10) Pub. No.: US 2024/0298218 A1
(43) Pub. Date: Sep. 5, 2024

(54) COMMUNICATION METHOD AND USER EQUIPMENT

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 18/647,715

(22) Filed: Apr. 26, 2024

Related U.S. Application Data
(63) Continuation of application No. PCT/JP2022/039829, filed on Oct. 26, 2022.

(30) Foreign Application Priority Data
Oct. 27, 2021 (JP) 2021-175942

(51) Int. Cl. H04W 36/00; H04W 36/36; H04W 76/20

(52) U.S. Cl. CPC H04W 36/0007; H04W 36/362; H04W 76/20

(57) ABSTRACT

A communication method performed by a UE in a mobile communication system for providing a multicast broadcast service (MBS) includes: a step S6 of receiving, from a source cell C1, a radio resource control (RRC) reconfiguration message including a conditional handover (CHO) configuration regarding a candidate cell C2 for CHO; and a step S9 of starting MBS reception from the candidate cell C2 using an MBS reception configuration before performing the CHO in response to the CHO configuration including the MBS reception configuration, the MBS reception configuration allowing an MBS session provided by the candidate cell through Point-To-Multipoint (PTM) to be received.

### RELATED APPLICATIONS

The present application is a continuation based on PCT Application No. PCT/JP2022/039829, filed on Oct. 26, 2022, which claims the benefit of Japanese Patent Application No. 2021-175942 filed on Oct. 27, 2021. The content of which is incorporated by reference herein in their entirety.

### TECHNICAL FIELD

The present disclosure relates to a communication method and a user equipment used in a mobile communication system.

### BACKGROUND

In 3rd Generation Partnership Project (3GPP) standards, technical specifications of New Radio (NR) being radio access technology of the fifth generation (5G) have been defined. NR has features such as high speed, large capacity, high reliability, and low latency, in comparison to Long Term Evolution (LTE) being radio access technology of the fourth generation (4G). In 3GPP, there have been discussions for establishing technical specifications of multicast and broadcast services (MBS) of 5G/NR (for example, see Non-Patent Document 1).

### CITATION LIST

### Non-Patent Literature

Non-Patent Document 1: 3GPP Contribution: RP-201038, “WID revision: NR Multicast and Broadcast Services”

### SUMMARY

5G/NR multicast and broadcast services are desired to provide enhanced services compared to 4G/LTE multicast and broadcast services.

The present disclosure provides an improved multicast broadcast service.

A communication method according to a first aspect is performed by a user equipment in a mobile communication system for providing a multicast broadcast service (MBS). The communication method includes: receiving, from a source cell, a radio resource control (RRC) reconfiguration message including a conditional handover (CHO) configuration regarding a candidate cell for CHO; and starting MBS reception from the candidate cell using an MBS reception configuration before performing the CHO in response to the CHO configuration including the MBS reception configuration, the MBS reception configuration allowing an MBS session provided by the candidate cell through Point-To-Multipoint (PTM) to be received.

A user equipment according to a second aspect is used in a mobile communication system for providing a multicast broadcast service (MBS). The user equipment includes: a receiver receiving, from a source cell, a radio resource control (RRC) reconfiguration message including a conditional handover (CHO) configuration regarding a candidate cell for CHO; and a controller starting MBS reception from the candidate cell using an MBS reception configuration before performing the CHO in response to the CHO configuration including the MBS reception configuration, the MBS reception configuration allowing an MBS session provided by the candidate cell through Point-To-Multipoint (PTM) to be received.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating an overview of MBS traffic delivery according to an embodiment.

FIG. 7 is a diagram illustrating delivery modes according to an embodiment.

FIG. 8 is a diagram illustrating an example of internal processing regarding MBS reception of the UE according to the embodiment.

FIG. 9 is a diagram illustrating another example of the internal processing regarding the MBS reception of the UE according to the embodiment.

FIG. 10 is a diagram illustrating a first operation scenario of the mobile communication system according to the embodiment.

FIG. 11 is a diagram illustrating a second operation scenario of the mobile communication system according to the embodiment.

FIG. 12 is a diagram illustrating an operation example of the mobile communication system according to the embodiment.

FIG. 13 is a diagram illustrating a packet, specifically, a PDCP data Protocol Data Unit (PDU), constituting MBS data.

FIG. 14 is a diagram illustrating a variation of an operation of the mobile communication system according to the embodiment.

FIG. 15 is a diagram illustrating an example of internal processing of a UE according to the variation.

FIG. 16 is a diagram illustrating an example of the internal processing of the UE according to the variation.

### DESCRIPTION OF EMBODIMENTS

A mobile communication system according to an embodiment is described with reference to the drawings. In the description of the drawings, the same or similar parts are denoted by the same or similar reference signs.

### Configuration of Mobile Communication System

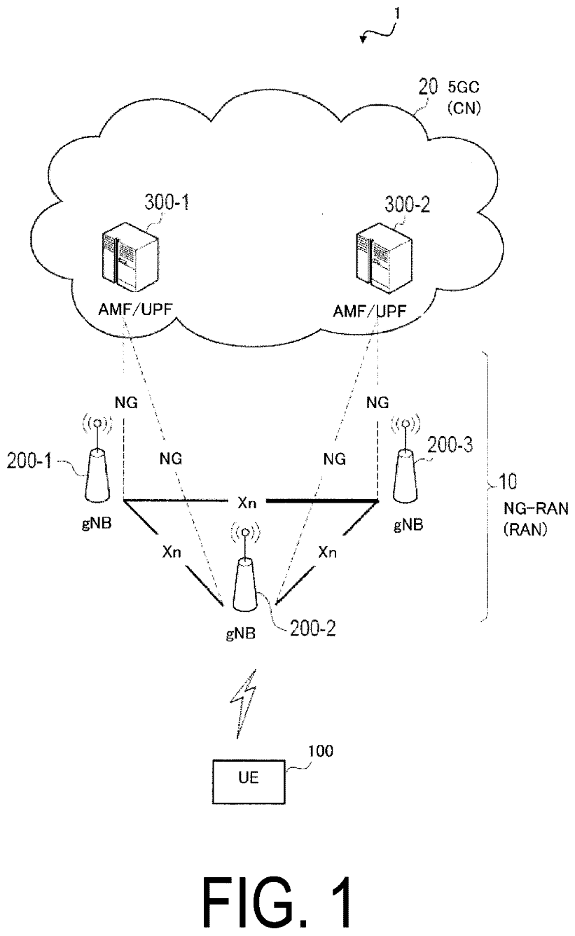

FIG. 1 is a diagram illustrating a configuration of a mobile communication system according to an embodiment. The mobile communication system 1 complies with the 5th Generation System (5GS) of the 3GPP standard. The description below takes the 5GS as an example, but a Long Term Evolution (LTE) system or a sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

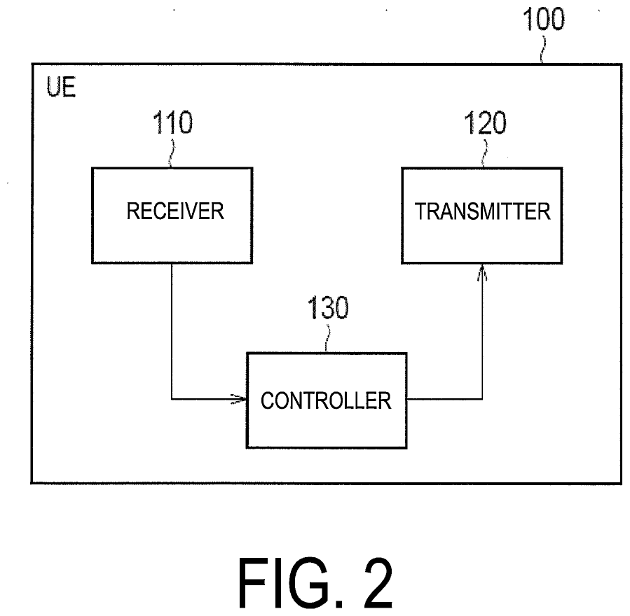

FIG. 2 is a diagram illustrating a configuration of the UE 100 (user equipment) to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processes in the UE 100. Such processes include processes of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

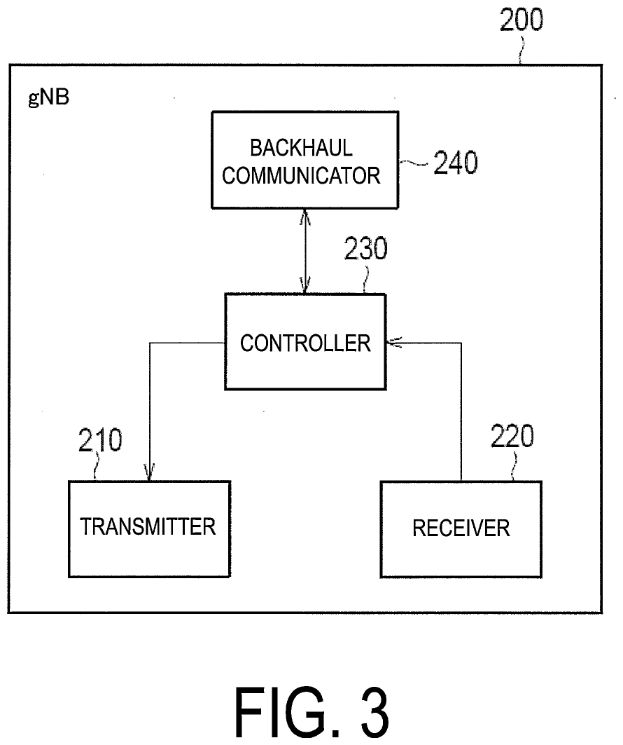

FIG. 3 is a diagram illustrating a configuration of the gNB 200 (base station) according to the embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processes in the gNB 200. Such processes include processes of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface between base stations. The backhaul communicator 240 is connected to the AMF/UPF 300 via a NG interface between a base station and the core network. Note that the gNB 200 may include a Central Unit (CU) and a Distributed Unit (DU) (i.e., functions are divided), and the two units may be connected via an F1 interface, which is a fronthaul interface.

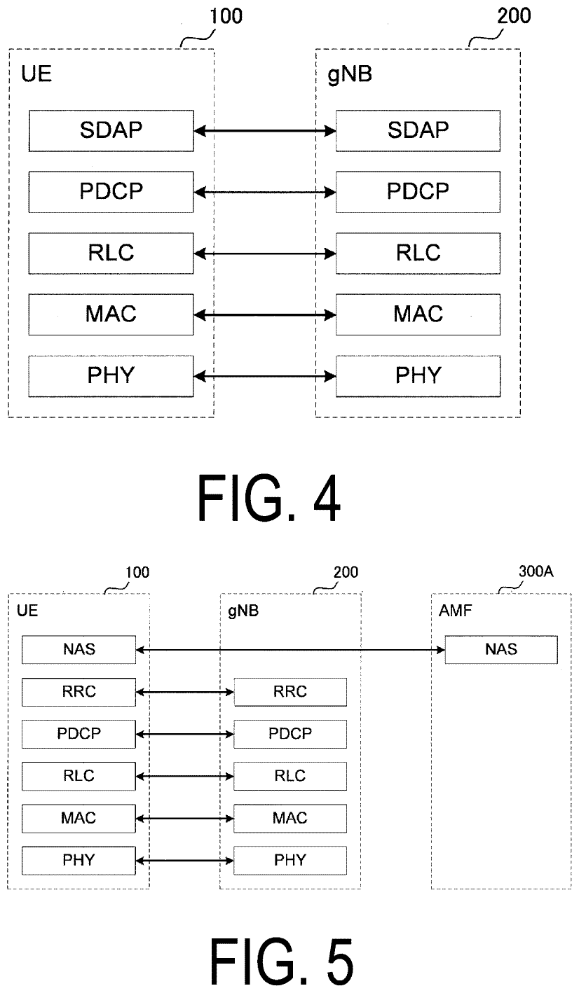

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer which is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. A layer lower than the NAS layer is referred to as an AS layer.

### Overview of MBS

An overview of the MBS according to an embodiment will be provided. The MBS is a service in which the NG-RAN 10 can provide broadcast or multicast, i.e., Point To Multipoint (PTM) data transmission to the UE 100. Assumed use cases (service types) of the MBS include public safety communication, mission critical communication, Vehicle to Everything (V2X) communication, IPv4 or IPv6 multicast delivery, Internet Protocol TeleVision (IPTV), group communication, and software delivery.

A broadcast service provides a service to every UE 100 within a particular service area for an application not requiring highly reliable QoS. An MBS session used for the broadcast service is referred to as a broadcast session.

A multicast service provides a service not to every UE 100, but to a group of UEs 100 participating in the multicast service (multicast session). An MBS session used for the multicast service is referred to as a multicast session.

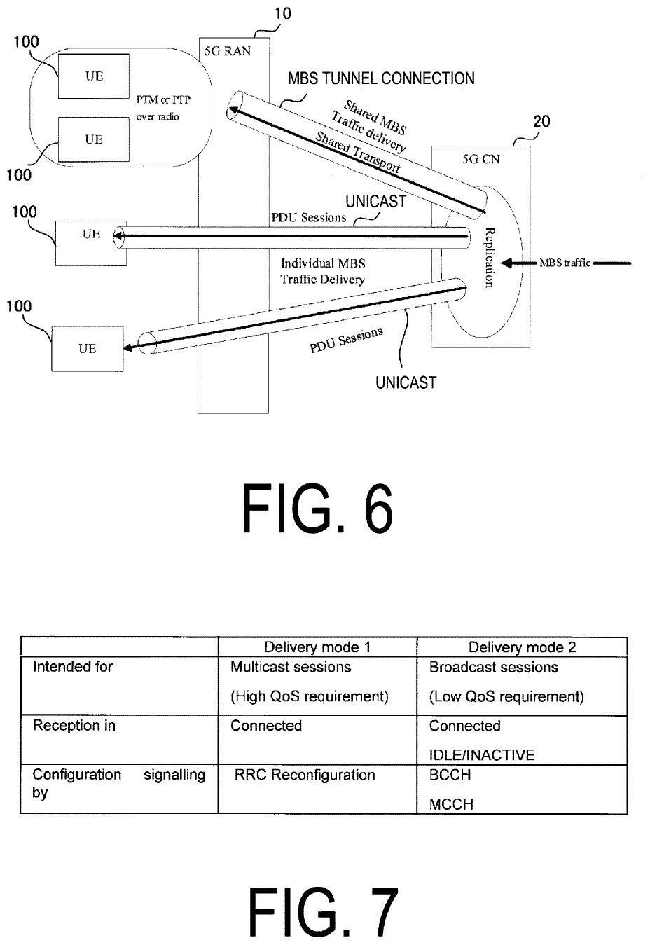

FIG. 6 is a diagram illustrating an overview of MBS traffic delivery according to an embodiment.

MBS traffic (MBS data) is delivered from a single data source (application service provider) to a plurality of UEs. The 5G CN (5GC) 20, which is a 5G core network, receives the MBS data from the application service provider and performs Replication of the MBS data to deliver the resultant.

From the perspective of the 5GC 20, two multicast delivery methods are possible: 5GC Shared MBS Traffic delivery and 5GC Individual MBS Traffic delivery.

In the 5GC individual MBS traffic delivery method, the 5GC 20 receives a single copy of MBS data packets and delivers individual copies of these MBS data packets to the individual UEs 100 via PDU sessions of the individual UEs 100. Thus, one PDU session for each UE 100 needs to be associated with a multicast session.

In the 5GC shared MBS traffic delivery method, the 5GC 20 receives a single copy of MBS data packets and delivers the single copy of the MBS packets to a RAN node (i.e., the gNB 200). The gNB 200 receives the MBS data packets via MBS tunnel connection, and delivers those to one or more UEs 100.

From the perspective of the RAN (5G RAN) 10, two delivery methods are possible for radio transmission of the MBS data in the 5GC shared MBS traffic delivery method: a Point-To-Point (PTP) delivery method and a Point-To-Multipoint (PTM) delivery method. PTP means unicast, and PTM means multicast and broadcast.

In the PTP delivery method, the gNB 200 wirelessly delivers the individual copies of the MBS data packets to the individual UEs 100. On the other hand, in the PTM delivery method, the gNB 200 wirelessly delivers the single copy of the MBS data packets to a group of the UEs 100. The gNB 200 can dynamically determine whether to use the PTM or PTP delivery method as a method for delivering the MBS data to one UE 100.

The PTP and PTM delivery methods are mainly related to the user plane. Modes for controlling the MBS data delivery include two delivery modes: a first delivery mode and a second delivery mode.

FIG. 7 is a diagram illustrating delivery modes according to an embodiment.

The first delivery mode (Delivery mode 1 (DM1)) is a delivery mode that can be used by the UE 100 in the RRC connected state, and is a delivery mode for high QoS requirements. The first delivery mode is used for multicast sessions among MBS sessions. Note that the first delivery mode may be used for broadcast sessions. The first delivery mode may be available to the UE 100 in the RRC idle state or the RRC inactive state.

MBS reception configuration in the first delivery mode is performed through UE-dedicated signaling. For example, the MBS reception configuration in the first delivery mode is performed through an RRC Reconfiguration message (or an RRC Release message), which is an RRC message unicast from the gNB 200 to the UE 100.

The MBS reception configuration includes MBS traffic channel configuration information (hereinafter referred to as “MTCH configuration information”) about configuration of an MBS traffic channel carrying MBS data. The MTCH configuration information includes MBS session information about an MBS session (including a below-described MBS session identifier) and scheduling information of an MTCH corresponding to the MBS session. The scheduling information of the MTCH may include a discontinuous reception (DRX) configuration of the MTCH. The discontinuous reception configuration may include at least one parameter selected from the group consisting of a timer value (On Duration Timer) for defining an on-period (On Duration: reception period), a timer value (Inactivity Timer) for extending the on-period, a scheduling interval or a DRX cycle (Scheduling Period, DRX Cycle), an offset value (Start Offset, DRX Cycle Offset) of a start subframe for scheduling or a DRX cycle, a start delay slot value (Slot Offset) of an on-period timer, a timer value (Retransmission Timer) for defining a maximum time until retransmission, and a timer value (HARQ RTT Timer) for defining a minimum interval until DL assignment of HARQ retransmission. Note that the multicast traffic channel (MTCH) is a type of logical channel. The MTCH is mapped to a downlink shared channel (Down Link-Shared CHannel (DL-SCH)) being a type of transport channel.

The second delivery mode (Delivery mode 2 (DM2)) is a delivery mode that can be used not only by the UE 100 in the RRC connected state, but also by the UE 100 in the RRC idle state or the RRC inactive state, and is a delivery mode for low QoS requirements. The second delivery mode is used for broadcast sessions among MBS sessions. However, the second delivery mode may also be applicable to multicast sessions.

An MBS reception configuration in the second delivery mode is performed through broadcast signaling. For example, the MBS reception configuration in the second delivery mode is performed using a logical channel transmitted from the gNB 200 to the UE 100 through broadcast, for example, a broadcast control channel (BCCH) and/or a multicast control channel (MCCH). The UE 100 can receive the BCCH and the MCCH, using a dedicated RNTI defined in technical specifications in advance, for example. The RNTI for BCCH reception may be an SI-RNTI, and the RNTI for MCCH reception may be an MCCH-RNTI.

In the second delivery mode, the UE 100 may receive the MBS data in the following three procedures. Firstly, the UE 100 receives MCCH configuration information using an MBS system information block (MBS SIB) transmitted from the gNB 200 on the BCCH. Secondly, the UE 100 receives the MCCH from the gNB 200, based on the MCCH configuration information. On the MCCH, MTCH configuration information is transmitted. The MCCH may include neighboring cell information indicating whether a currently provided MBS session is also provided in a neighboring cell. Thirdly, the UE 100 receives the MTCH (MBS data), based on the MTCH configuration information. The MTCH configuration information and/or the MCCH configuration information may be hereinafter referred to as the MBS reception configuration.

In the first delivery mode and the second delivery mode, the UE 100 may receive the MTCH, using a group RNTI (G-RNTI) assigned from the gNB 200. The G-RNTI corresponds to an RNTI for MTCH reception. The G-RNTI may be included in the MBS reception configuration (MTCH configuration information).

The network can provide different MBS services for different MBS sessions. The MBS session is identified by at least one selected from the group consisting of a Temporary Mobile Group Identity (TMGI), a source-specific IP multicast address (which consists of a source unicast IP address, such as an application function and an application server, and an IP multicast address indicating a destination address), a session identifier, and a G-RNTI. At least one selected from the group consisting of the TMGI, the source specific IP multicast address, and the session identifier is referred to as an MBS session identifier. The TMGI, the source-specific IP multicast address, the session identifier, and the G-RNTI are collectively referred to as MBS session information.

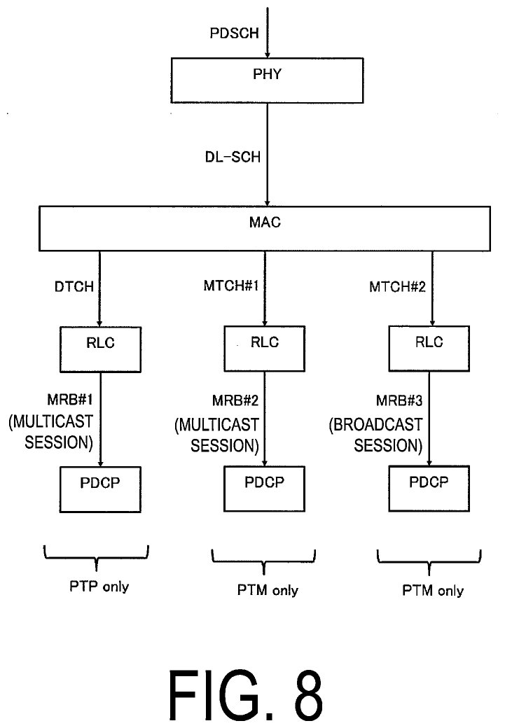

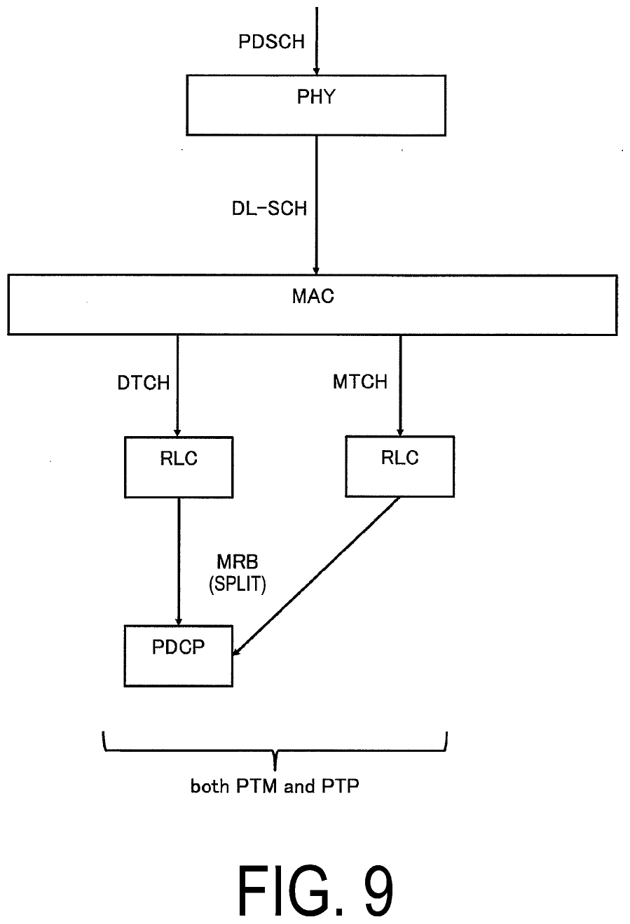

FIG. 8 is a diagram illustrating an example of internal processing regarding MBS reception of the UE 100 according to the embodiment. FIG. 9 is a diagram illustrating another example of the internal processing regarding the MBS reception of the UE 100 according to the embodiment.

One MBS radio bearer (MRB) is one radio bearer carrying a multicast session or a broadcast session. That is, there is a case where the multicast session is associated with the MRB and a case where the broadcast session is associated with the MRB.

The gNB 200 configures the MRB and a corresponding logical channel (e.g., MTCH) in the UE 100 by RRC signaling. An MRB configuration procedure may be separated from a data radio bearer (DRB) configuration procedure. In RRC signaling, one MRB can be configured with “PTM only”, “PTP only”, or “both PTM and PTP”. The bearer type of such an MRB can be changed by RRC signaling.

FIG. 8 illustrates an example in which a multicast session and a dedicated traffic channel (DTCH) are associated with an MRB #1, a multicast session and an MTCH #1 are associated with an MRB #2, and a broadcast session and an MTCH #2 are associated with an MRB #3. That is, the MRB #1 is a PTP only MRB, the MRB #2 is a PTM only MRB, and the MRB #3 is a PTM only MRB. Note that the DTCH is scheduled using a cell RNTI (C-RNTI). The MTCH is scheduled using a G-RNTI.

The PHY layer of the UE 100 processes user data (received data) received on the PDSCH, which is one of physical channels, and routes the processed user data to the downlink shared channel (DL-SCH), which is one of transport channels. The MAC layer (MAC entity) of the UE 100 processes the data received on the DL-SCH and routes the received data to a corresponding logical channel (corresponding RLC entity) based on a logical channel identifier (LCID) included in the header (MAC header) included in the received data.

FIG. 9 illustrates an example in which a DTCH and an MTCH are associated with an MRB associated with a multicast session. Specifically, one MRB is split into two legs, one leg is associated with the DTCH, and the other leg is associated with the MTCH. The two legs are joined at the PDCP layer (PDCP entity). That is, the MRB is an MRB of both PTM and PTP. Such an MRB may be referred to as a split MRB.

### Operation of Mobile Communication System

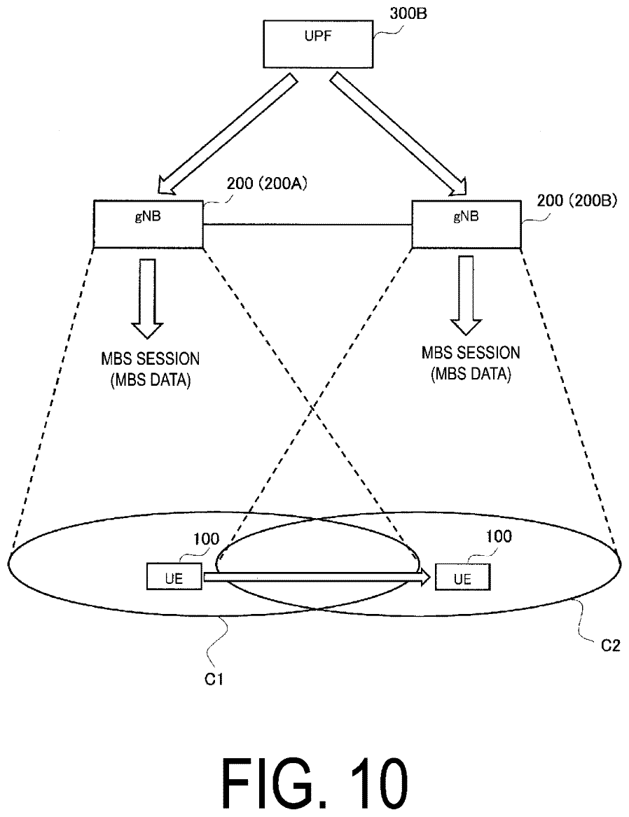

FIG. 10 is a diagram illustrating a first operation scenario of the mobile communication system 1 according to the embodiment.

A gNB 200A manages a cell C1, and a gNB 200B in a neighboring relationship with the gNB 200A manages a cell C2. Coverage of the cell C1 and the cell C2 at least partially overlap. The gNB 200A and the gNB 200B are connected to each other via an Xn interface being an interface between base stations. Inter-base station communication between the gNB 200A and the gNB 200B is performed on the Xn interface.

The gNB 200A provides an MBS session in the cell C1. Specifically, the gNB 200A receives MBS data belonging to the MBS session from a UPF 300B, and transmits the MBS data in the cell C1 through PTM (multicast/broadcast). The UE 100 in the RRC connected state performs reception (MBS reception) of the MBS data transmitted in the cell C1 through PTM. The reception of the MBS data (MBS reception) transmitted through PTM is also referred to as PTM reception.

The gNB 200B provides an MBS session in the cell C2. Specifically, the gNB 200B receives MBS data belonging to the MBS session from a UPF 300B, and transmits the MBS data in the cell C2 through PTM. In the cell C2, the gNB 200B may provide the same MBS session as the MBS session provided in the cell C1.

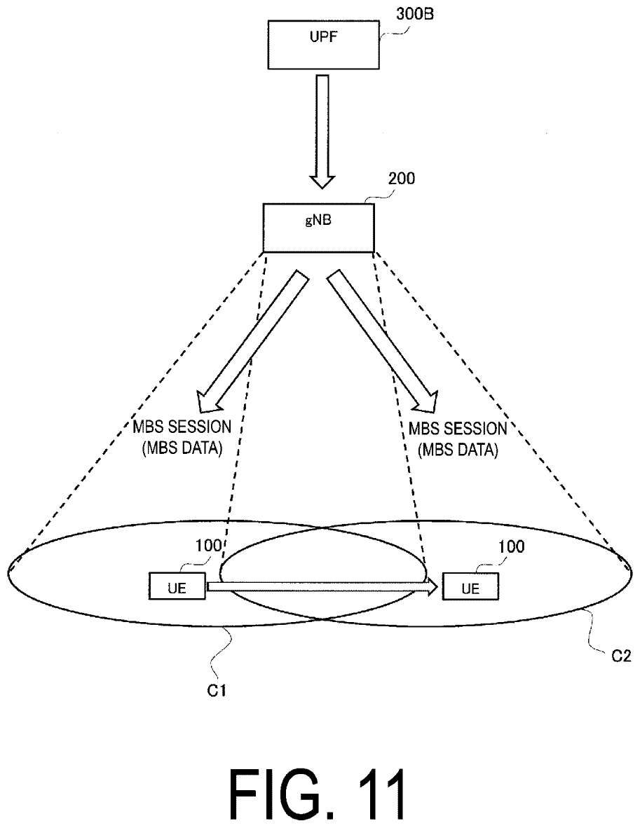

FIG. 11 is a diagram illustrating a second operation scenario of the mobile communication system 1 according to the embodiment.

The second operation scenario is different from the first operation scenario in that the cell C1 and the cell C2 are managed by one gNB 200. The gNB 200 provides an MBS session in each of the cell C1 and the cell C2. Specifically, the gNB 200 transmits the MBS data in each of the cell C1 and the cell C2 through PTM (multicast/broadcast).

In the first operation scenario and the second operation scenario, the UE 100 in the RRC connected state moves from the cell C1 toward the cell C2. For example, the gNB 200 (gNB 200A) determines handover (HO) of the UE 100 to the cell C2 based on a measurement report from the UE 100 and transmits an HO command to the UE 100. In response to reception of the HO command, the UE 100 accesses the cell C2 (gNB 200B). In the course of such an HO procedure, there is a problem in that PTM reception of the UE 100 is temporarily interrupted and loss may occur in MBS data received by the UE 100. Note that, under the assumption that the HO of the UE 100 from the cell C1 to the cell C2 is performed, the cell C1 and the gNB 200A are referred to as a source cell and a source gNB respectively, and the cell C2 and the gNB 200B are referred to as a target cell and a target gNB respectively.

In addition, when the radio quality between the UE 100 and the cell C1 (gNB 200A) rapidly deteriorates, the UE 100 may transition to the RRC idle state due to a radio link failure (RLF) or the like without receiving the HO command from the gNB 200A. In such a case, for example, there is a problem in that the UE 100 may have difficulty in continuing reception of an MBS session to which the first delivery mode is applied.

In the embodiment, the problem as described above can be solved by using conditional handover (CHO). Note that, under the assumption that the HO of the UE 100 from the cell C1 to the cell C2 is performed, the cell C1 and the gNB 200A are referred to as a source cell and a source gNB respectively, and the cell C2 and the gNB 200B are referred to as a candidate cell and a candidate gNB respectively.

Now, overview of typical CHO will be described. The CHO is defined as HO performed by the UE 100 when an HO execution condition is met. When receiving an RRC Reconfiguration message including a CHO configuration from the source cell C1 (source gNB 200A), the UE 100 starts evaluating the execution condition and, once the HO is performed, stops evaluating the execution condition. The CHO configuration includes a candidate cell configuration generated by the candidate gNB 200B and the execution condition generated by the source gNB 200A. The candidate cell configuration and the execution condition are associated with each other. A set of the candidate cell configuration and the execution condition may be provided for each of the plurality of candidate cells. Such a CHO configuration is also referred to as a Conditional Reconfiguration. The execution condition is information for configuring the radio quality of a measurement target, a threshold value to be compared with the radio quality, and the like. During the execution of the CHO, i.e., from when the UE 100 starts synchronization with the candidate cell C2, the UE 100 does not monitor the source cell.

In the embodiment, the source cell C1 (source gNB 200A) includes an MBS reception configuration (e.g., MTCH configuration information) for receiving an MBS session provided by the candidate cell C2 through PTM in the CHO configuration regarding the candidate cell C2 (specifically, the candidate cell configuration of the candidate cell C2). The UE 100 receives the RRC Reconfiguration message including the CHO configuration (Conditional Reconfiguration) from the source cell C1. In response to the CHO configuration including the MBS reception configuration for receiving the MBS session provided by the candidate cell C2 through PTM, the UE 100 starts MBS reception from the candidate cell C2 using the MBS reception configuration before performing the CHO. This makes it easier for the UE 100 to continue receiving the MBS session.

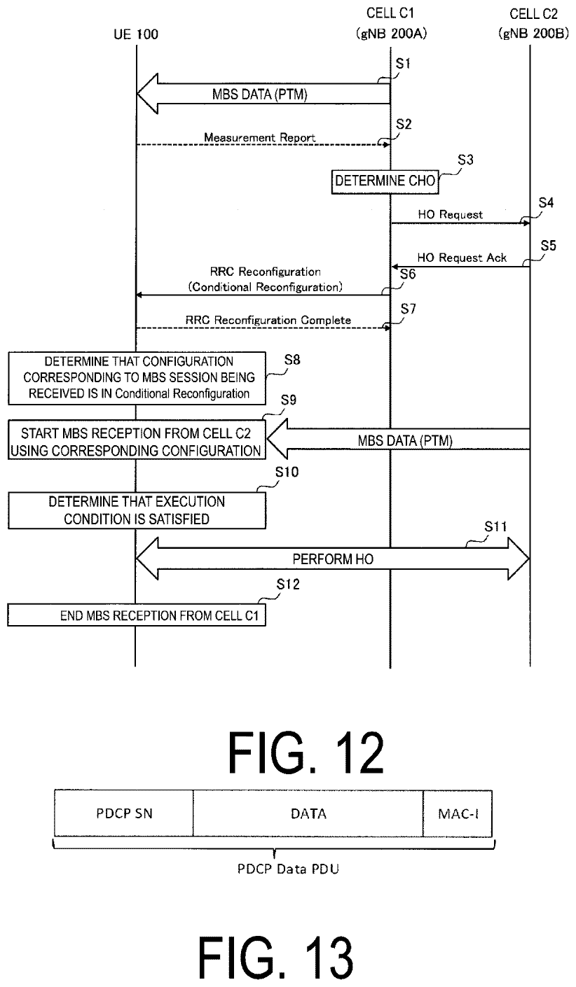

FIG. 12 is a diagram illustrating an operation example of the mobile communication system 1 according to the embodiment.

In Step S1, the UE 100 in the RRC connected state receives an MBS session (MBS data) provided by the source cell C1 (source gNB 200A) through PTM. The MBS session may be a multicast session or a broadcast session. Such an MBS session is referred to as a desired MBS session.

In Step S2, the UE 100 may perform measurement of each cell based on a measurement configuration performed by the source cell C1 (source gNB 200A) and transmit a Measurement Report including a measurement result to the source cell C1 (source gNB 200A).

In Step S3, the source cell C1 (source gNB 200A) determines to perform CHO based on, for example, the Measurement Report.

In Step S4, the source cell C1 (source gNB 200A) transmits an HO request message for requesting the CHO to the candidate cell C2 (candidate gNB 200B). The source cell C1 (source gNB 200A) may transmit the HO request message to a plurality of the candidate cells C2 (plurality of the candidate gNBs 200B).

In Step S5, the candidate cell C2 (candidate gNB 200B) transmits an HO response (HO Request Acknowledge) message for acknowledging the CHO to the source cell C1 (source gNB 200A). The HO response includes a candidate cell configuration of the candidate cell C2. The candidate cell configuration includes various configurations necessary for the UE 100 to perform wireless communication with the candidate cell C2. In the embodiment, the candidate cell configuration includes an MBS reception configuration (e.g., MTCH configuration information) for an MBS session provided by the candidate cell C2 through PTM.

In Step S6, the source cell C1 (source gNB 200A) transmits, to the UE 100, an RRC Reconfiguration message including an execution condition determined by the source cell C1 and the candidate cell configuration received from the candidate cell C2 (candidate gNB 200B) as a CHO configuration (Conditional Reconfiguration).

In Step S7, the UE 100 may transmit, to the source cell C1 (source gNB 200A), an RRC Reconfiguration Complete message in response to the RRC Reconfiguration message from the source cell C1 (source gNB 200A). Note that Step S7 may be performed after Step S8 or Step S9.

In Step S8, the UE 100 determines whether the CHO configuration (Conditional Reconfiguration), specifically, the candidate cell configuration, includes the MBS reception configuration for receiving the MBS session provided by the candidate cell C2 through PTM. When the CHO configuration (Conditional Reconfiguration) includes the MBS reception configuration, the UE 100 may determine whether the candidate cell C2 provides the same MBS session (desired MBS session) as the MBS session provided by the source cell C1 based on the MBS reception configuration. For example, when the candidate cell configuration includes the MBS session identifier (e.g., TMGI) of the desired MBS session, the UE 100 may determine that the candidate cell C2 provides the desired MBS session. Here, description will be given on the assumption that the UE 100 determines that the candidate cell C2 provides the desired MBS session.

In Step S9, the UE 100 starts MBS reception from the candidate cell C2 using the MBS reception configuration. Specifically, the UE 100 starts receiving the MBS session (desired MBS session) provided by the candidate cell C2 through PTM using the MBS reception configuration for the desired MBS session. Note that when a plurality of the candidate cells provide the desired MBS session, the UE 100 may receive the MBS session from each of the plurality of candidate cells or may perform the MBS reception only from a candidate cell under a good radio condition (RSRP or the like).

In Step S10, the UE 100 determines whether the HO execution condition regarding the candidate cell C2 is satisfied. In this regard, the following description will be given on the assumption that the UE 100 determines that the HO execution condition regarding the candidate cell C2 is satisfied.

In Step S11, the UE 100 performs HO to the candidate cell C2. Specifically, the UE 100 applies the candidate cell configuration of the candidate cell C2, synchronizes with the candidate cell C2, and transmits an RRC Reconfiguration Complete message to the candidate cell C2. The candidate cell C2 (candidate gNB 200B) that has received the RRC Reconfiguration Complete message may transmit an HO success (HANDOVER SUCCESS) message to the source cell C1 (source gNB 200A).

In Step S12, the UE 100 may continue the MBS reception from the source cell C1 (source gNB 200A) for a certain period of time after starting the synchronization with the candidate cell C2 and may end the MBS reception from the source cell C1 (source gNB 200A) after the elapse of the certain period of time. The certain period of time may be configured in the UE 100 from the source cell C1 (source gNB 200A).

### Variations

In the above embodiment, the UE 100 starts MBS reception from the candidate cell C2 before performing CHO. Thus, the UE 100 receives a packet belonging to the same MBS session from each of the source cell C1 and the candidate cell C2. As a result, redundancy may occur between the received packet from the source cell C1 and the received packet from the candidate cell C2. In this variation, when redundancy occurs between the received packet from the source cell C1 and the received packet from the candidate cell C2, the UE 100 discards one of the duplicate packets.

Here, the packet may be a PDCP packet. FIG. 13 is a diagram illustrating a packet constituting MBS data, specifically, a PDCP data Protocol Data Unit (PDU). The PDCP data PDU includes a PDCP sequence number (SN), data and a MAC-I. The PDCP SN is a sequence number sequentially assigned to the PDCP data PDU. The data corresponds to a PDCP Service Data Unit (SDU). The MAC-I corresponds to a message authentication code. The PDCP data PDU may not include the MAC-I.

In this variation, it is assumed that the same sequence number (PDCP SN) is assigned to the same packet (IP packet) in the source cell C1 (source gNB 200A) and the candidate cell C2 (candidate gNB 200B). Because one PDCP PDU is generated for each single IP packet, on the condition that the PDCP SNs of the first IP packets match in the two cells, correspondence between subsequent MBS packets and PDCP SNs match regardless of the cells.

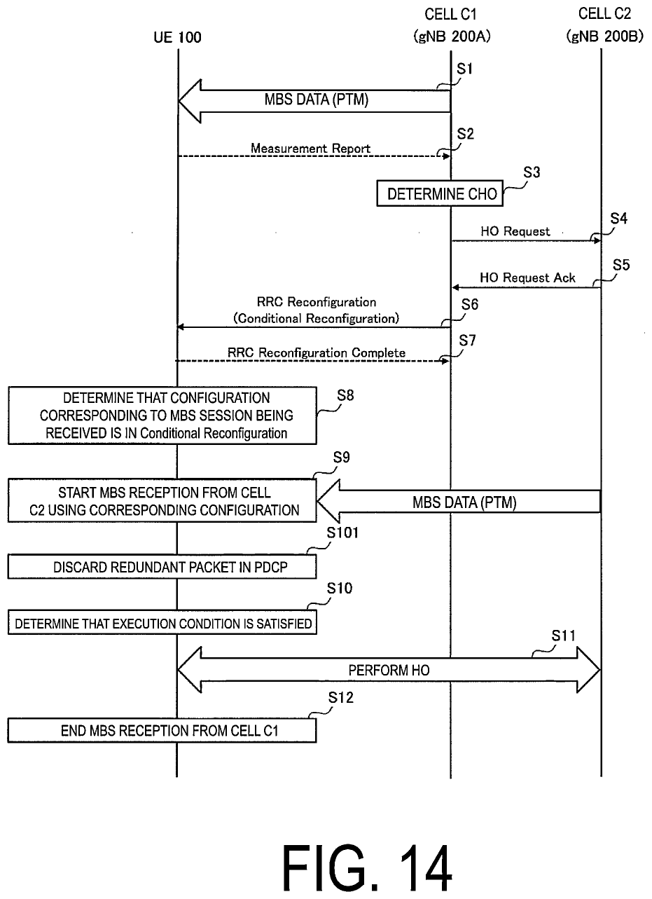

FIG. 14 is a diagram illustrating a variation of an operation of the mobile communication system 1 according to the embodiment. Here, differences from the operation of the embodiment described above (see FIG. 12) will be described.

In Step S101, the PDCP entity of the UE 100 detects a redundant packet based on the PDCP sequence number included in each received packet. Specifically, the PDCP entity of the UE 100 that receives a packet belonging to the same MBS session from each of the source cell C1 and the candidate cell C2 recognizes that the packets overlap and discards one of the packets when the PDCP SN of the packet received from the source cell C1 and the PDCP SN of the packet received from the candidate cell C2 match.

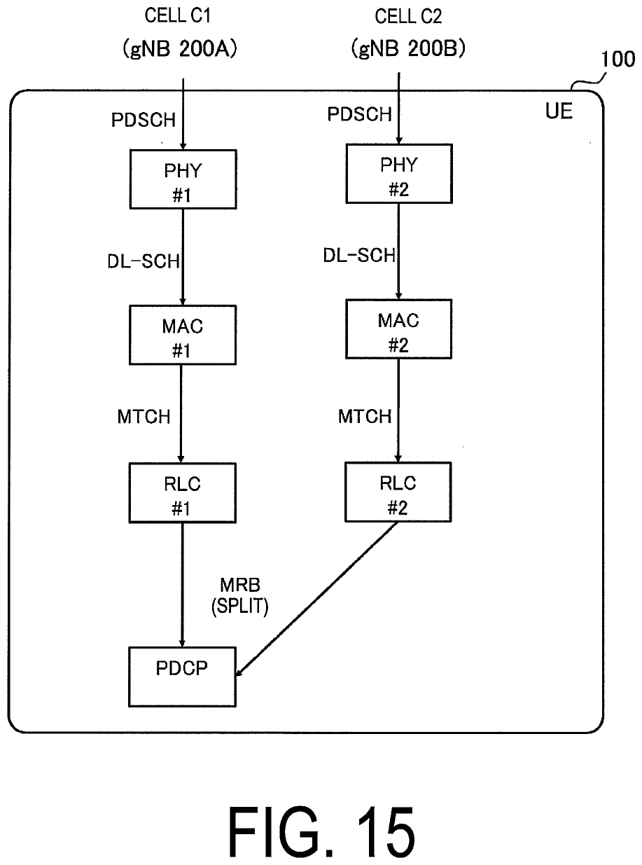

FIG. 15 is a diagram illustrating an example of internal processing of the UE 100 according to the present variation.

The UE 100 establishes one PDCP entity that terminates a first MBS transmission path from the source cell C1 to the UE 100 and a second MBS transmission path from the candidate cell C2 to the UE 100. That is, a PTM path (MTCH) from the source cell C1 and a PTM path (MTCH) from the candidate cell C2 are terminated at the same PDCP entity.

For example, when starting MBS session (PTM) reception from the candidate cell C2, the UE 100 associates the MTCH of the candidate cell C2 with an MRB of the MBS session (configured by the source cell C1). That is, from the viewpoint of the UE 100, a split MRB (a split MRB of a PTM-leg and a PTM-leg) for the source cell C1 and the candidate cell C2 is configured. Such processing is performed only when the MBS session identifier associated with the MRB associated with the MTCH of the candidate cell C2 matches the MBS session identifier of the MRB of the source cell C1.

In such a configuration, the PDCP entity of the UE 100 that receives packets (PDCP PDUs) from the source cell C1 and the candidate cell C2 discards one of the packets when detecting duplicate packets. For example, the PDCP entity of the UE 100 discards a packet dropped from the receive window among the overlapping packets. As described above, one PDCP PDU (i.e., one PDCP SN) is generated for one IP packet. Thus, even when the source cell C1 and the candidate cell C2 transmit packets with different PDCP SNs (even in the case of not being synchronized) at a certain point in time, the PDCP SNs themselves are associated with the same packet. Thus, the PDCP entity of the UE 100 can recognize whether an IP packet is redundant by checking the PDCP SNs.

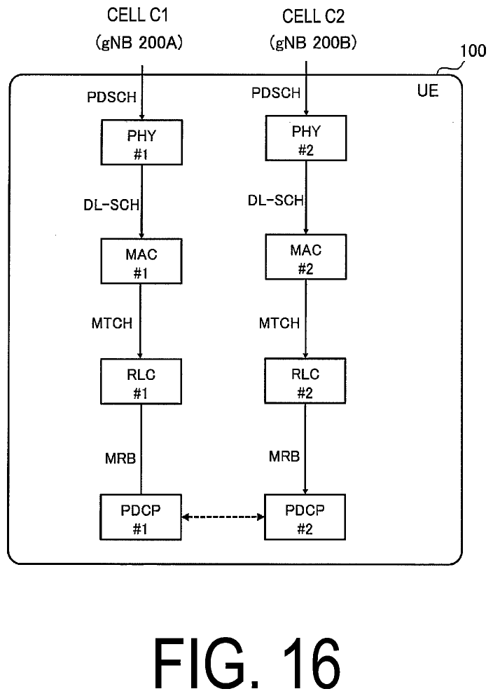

FIG. 16 is a diagram illustrating another example of the internal processing of the UE 100 according to the present variation.

The UE 100 establishes a PDCP entity #1 (first PDCP entity) that terminates a first MBS transmission path from the source cell C1 to the UE 100 and a PDCP entity #2 (second PDCP entity) that terminates a second MBS transmission path from the candidate cell C2 to the UE 100. That is, a PTM path (MTCH) from the source cell C1 and a PTM path (MTCH) from the candidate cell C2 are terminated at different PDCP entities.

For example, when starting MBS session (PTM) reception from the candidate cell C2, the UE 100 configures a corresponding MRB of the candidate cell C2, that is, an MRB (PDCP entity #2) different from an MRB (PDCP entity #1) of the source cell C1. Here, the UE 100 identifies the MRB (PDCP entity #1) of the source cell C1 associated with the same MBS session identifier as the generated MRB (PDCP entity #2).

In the UE 100 that receives a packet (PDCP PDU) from each of the source cell C1 and the candidate cell C2, the PDCP entity #2 of the candidate cell C2 inquires of the PDCP entity #1 of the source cell C1 about the PDCP SN of the received packet, discards the packet when the packet has been already received, and transfers the packet to the upper layer when the packet has not been received. The PDCP entity #1 of the source cell C1 may consider that the PDCP SN has been already received.

### Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow.

In the embodiments and examples described above, an example in which the base station is an NR base station (i.e., a gNB) is described; however, the base station may be an LTE base station (i.e., an eNB) or a 6G base station. The base station may be a relay node such as an Integrated Access and Backhaul (IAB) node. The base station may be a DU of the IAB node. The user equipment may be a Mobile Termination (MT) of the IAB node.

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be implemented as a semiconductor integrated circuit (chipset, system on a chip (SoC)).

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### REFERENCE SIGNS

1: Mobile communication system
10: RAN
20: CN
100: UE
110: Receiver
120: Transmitter
130: Controller
200: gNB
210: Transmitter
220: Receiver
230: Controller
240: Backhaul communicator

1. A communication method performed by a user equipment in a mobile communication system for providing a multicast broadcast service (MBS), the communication method comprising the steps of:
receiving, from a source cell, a radio resource control (RRC) reconfiguration message comprising a conditional handover (CHO) configuration regarding a candidate cell for CHO; and
starting MBS reception from the candidate cell using an MBS reception configuration before performing the CHO in response to the CHO configuration comprising the MBS reception configuration, the MBS reception configuration being configured to allow an MBS session provided by the candidate cell through Point-To-Multipoint (PTM) to be received.

2. The communication method according to claim 1, further comprising the steps of:
receiving an MBS session provided by the source cell through PTM; and
determining, based on the MBS reception configuration, whether the candidate cell provides the same MBS session as the MBS session provided by the source cell, wherein
the starting comprises starting the MBS reception from the candidate cell using the MBS reception configuration before performing the CHO, when determining that the candidate cell provides the same MBS session.

3. The communication method according to claim 2, further comprising the steps of:
receiving a packet belonging to the same MBS session from each of the source cell and the candidate cell; and
discarding one of duplicate packets when redundancy occurs between the packet received from the source cell and the packet received from the candidate cell.

4. The communication method according to claim 3, wherein
the packet is a Packet Data Convergence Protocol (PDCP) packet, and
the discarding comprises the steps of:
detecting, by a PDCP entity of the user equipment, the duplicate packets based on a PDCP sequence number comprised in each of the packets received, and
discarding, by the PDCP entity of the user equipment, one of the duplicate packets.

5. The communication method according to claim 1, further comprising:
establishing one PDCP entity terminating a first MBS transmission path from the source cell to the user equipment and a second MBS transmission path from the candidate cell to the user equipment.

6. The communication method according to claim 1, further comprising:
establishing a first PDCP entity terminating a first MBS transmission path from the source cell to the user equipment and a second PDCP entity terminating a second MBS transmission path from the candidate cell to the user equipment.

7. A user equipment used in a mobile communication system for providing a multicast broadcast service (MBS), the user equipment comprising:
a receiver configured to receive, from a source cell, a radio resource control (RRC) reconfiguration message comprising a conditional handover (CHO) configuration regarding a candidate cell for CHO; and
a controller configured to start MBS reception from the candidate cell using an MBS reception configuration before performing the CHO in response to the CHO configuration comprising the MBS reception configuration, the MBS reception configuration being configured to allow an MBS session provided by the candidate cell through Point-To-Multipoint (PTM) to be received.
